(19) United States
(12) Patent Application Publication
(10) Pub. No.: US 2006/0259617 A1
(43) Pub. Date: Nov. 16, 2006

(54) Method and system for transmitting data between nodes in a mesh network

(75) Inventor: Sung-Won Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/432,386

(22) Filed: May 12, 2006

Related U.S. Application Data
(60) Provisional application No. 60/680,043, filed on May 12, 2005.

(30) Foreign Application Priority Data
Apr. 26, 2006 (KR) 2006-37825

(51) Int. Cl. G06F 15/173

(52) U.S. Cl. 709/224

(57) ABSTRACT

A method and system for transmitting data between mesh nodes in a mesh network are provided. A mesh node establishes a connection with at least one neighbor mesh node. Upon generation of data to be transmitted to the neighbor mesh node, the mesh node broadcasts a control message destined for the mesh node and reserves data transmission to the neighbor mesh node by competing with at least one legacy STA connected to the neighbor mesh node. When the neighbor mesh node permits the data transmission, the mesh node transmits the data to the neighbor mesh node.

### CROSS-REFERENCE TO RELATED APPLICATIONS

This application claims priority under 35 U.S.C. §119(e) to application Ser. No. 60/680,043 filed in the U.S. Patent and Trademark Office on May 12, 2005 and claims priority under 35 U.S.C. §119(a) to application Serial No. 2006-37825 filed on Apr. 26, 2006 in the Korean Intellectual Property Office, the entire disclosure of both of which are hereby incorporated by reference.

### BACKGROUND OF THE INVENTION

1. Field of the Invention

The present invention relates generally to a method and system for transmitting data in a mesh network. In particular, the present invention relates to a method and system for transmitting data between mesh nodes in a mesh network.

2. Description of the Related Art

Today, mobile communication technology is being developed toward maximizing transmission rate and efficiency of frequency use in order to provide multimedia service. A major example is a mobile access network. A mobile access network refers to a network that provides high-speed wireless service to terminals within a predetermined service coverage area.

Traditionally, the mobile access network is a set of local networks each including Access Points (AP) and legacy stations (STAs). A legacy STA receives an intended radio service by associating with an AP.

The mobile access network is evolving to a mesh network which is a wireless extended combination of a plurality of local networks. The mesh network is comprised of a plurality of mesh nodes. Each mesh node is so configured that it not only serves as an AP in a local network but also exchanges information directly with neighbor APs by associating with them using radio resources. The mesh nodes can be associated wirelessly or by cable. In the latter case, the distance between mesh nodes is not considered. In the former case, full consideration about the distance is required. Mesh nodes associated wirelessly must be located within a distance that allows information transfer by radio resources.

FIG. 1 illustrates the configuration of a typical mesh network in which mesh nodes are wirelessly associated with each other. In the illustrated case of FIG. 1, a mesh network formed with two mesh nodes is considered.

Referring to FIG. 1, a first mesh node 110 is spaced from a second mesh node 120 by a distance that allows information transfer by radio resources. A first area, Area #1 supports a wireless communication service from the first mesh node 10, and a second area, Area #2 supports a wireless communication service from the second mesh node 120.

Legacy STAs 111 to 116 are associated with the first mesh node 110, and legacy STAs 121 to 126 with the second mesh node 120. Hence, it is preferred that the legacy STAs 111 to 116 receive only signals from the first mesh node 110 and the legacy STAs 121 to 126 receive only signals from the second mesh node 120. In other words, interference from unintended signals must be minimized.

The mesh network having the above configuration must enable data transfer between mesh nodes as well as between the mesh network and legacy STAs. How data is transferred between mesh nodes depends on the structure of the radio interface of each mesh node and a resource allocation scheme used.

In a case where each mesh node has a multi-radio interface and the mesh network uses a plurality of radio channels, the mesh node uses a radio interface and a radio channel for data transfer with a legacy STA separately from those for data transfer with a neighbor mesh node, to thereby minimize interference from unintended signals. However, the multi-radio interface may increase the structural complexity of the mesh node.

In a case where each mesh node has a single radio interface and the mesh network uses a plurality of radio channels, the mesh node can use a radio interface and a radio channel for data transfer with a legacy STA separately from those for data transfer with a neighbor mesh node, to thereby minimize interference from unintended signals. However, the mesh node has to switch one radio channel to another depending on the recipient. In addition, a communication period for a legacy STA and a communication period for a neighbor mesh Node must be pre-defined over a total data transmission period.

In a case where each mesh node has a single radio interface and the mesh network uses a single radio channel, a communication period for a legacy STA and a communication period for a neighbor mesh Node must be pre-defined over a total data transmission period. Furthermore, a technique for preventing a signal transmitted during the communication period for the neighbor mesh node from interfering with the legacy STA is required.

In the above second and third cases, transmission periods need to be separated according to communication parties. Information associated with the division of transmission periods must be shared among neighbor mesh nodes, thus increasing signaling complexity in data transmission. Also, radio resources are wasted in a corresponding transmission period, in the absence of transmission data to the neighbor mesh node or the legacy STA, or in the absence of data to be received from the neighbor mesh node or the legacy STA.

In the third case, the signal destined for the neighbor mesh node is received at the legacy STA, thereby interfering with the legacy STA. To overcome this problem, power saving mode can be applied to the legacy STA. During the transmission period for communications with the neighbor mesh node, the legacy STA is transitioned to the power saving mode. In this case, the mesh node can command the legacy STA to transition to the power saving mode only at a preset time point. As a result, it may occur that the legacy STA is excessively kept in the power saving mode. This causes a decrease of Quality of Service (QoS) in the mesh network.

Accordingly, there exists a pressing need for a method of transmitting data between mesh nodes, while minimizing resource waste and preventing interference in a legacy STA in a mesh network.

### SUMMARY OF THE INVENTION

An exemplary object of the present invention is to address at least the above problems and/or disadvantages and to provide at least the advantages below. Accordingly, exemplary embodiments of the present invention provide a method and system for transmitting data between mesh nodes in order to improve performance in a mesh network.

Exemplary embodiments of the present invention provide a method and system for transmitting data from a mesh node having a single radio interface to a neighbor mesh mode, only when data transmission is required.

Exemplary embodiments of the present invention provide a data transmission method and system for, when a mesh node transmits data to its neighbor mesh node, enabling the neighbor mesh node to consider the transmitting mesh node as a legacy STA.

Exemplary embodiments of the present invention provide a data transmission method and system for, upon generation of transmission data destined for a neighbor mesh node in a mesh node, transitioning a legacy STA that may be interfered from the transmission data into a wait mode.

Exemplary embodiments of the present invention provide a data transmission method and system for estimating the period of transmitting data to a neighbor mesh node and informing a legacy STA of the estimated data transmission period in a mesh node.

According to one exemplary aspect of the present invention, in a data transmission method in a mesh node having a single radio interface in a mesh network supporting multiple channels, the mesh node establishes a connection with at least one neighbor mesh node. Upon generation of data to be transmitted to the neighbor mesh node, the mesh node broadcasts a control message destined for the mesh node and reserves data transmission to the neighbor mesh node by competing with at least one legacy STA connected to the neighbor mesh node. When the neighbor mesh node permits the data transmission, the mesh node transmits the data to the neighbor mesh node.

According to another exemplary aspect of the present invention, a data transmission system in a mesh network supporting multiple channels includes a receiving mesh node for permitting data transmission to a transmitting mesh node which has competed with at least one legacy STA connected to the receiving mesh node, the transmitting mesh node for establishing a connection with the receiving mesh node and transmitting data to the receiving mesh node, and at least one legacy STA connected to the transmitting mesh node. The transmitting mesh node has a single radio interface and is adapted to broadcast a control message destined for the transmitting mesh node, upon generation of data to be transmitted to the receiving mesh node, reserving the data transmission to the neighbor mesh node by competing with the at least one legacy STA connected to the receiving mesh node, and transmitting the data to the receiving mesh node, when the neighbor mesh node permits the data transmission.

### BRIEF DESCRIPTION OF THE DRAWINGS

The above and other objects, features and advantages of exemplary embodiments of the present invention will become more apparent from the following detailed description when taken in conjunction with the accompanying drawings in which:

FIG. 1 illustrates the configuration of a typical mesh network;

FIG. 2 is a diagram illustrating a signal flow for data transmission between mesh nodes in a mesh network according to an exemplary embodiment of the present invention;

FIGS. 3A to 3E illustrate a mesh network state in each step of the data transmission procedure between mesh nodes according to an exemplary embodiment of the present invention;

FIG. 4 is a flowchart illustrating a control operation for data transmission between mesh nodes in a transmitting mesh node according to an exemplary embodiment of the present invention; and

FIG. 5 is a flowchart illustrating a control operation for data transmission between mesh nodes in a legacy STA according to an exemplary embodiment of the present invention.

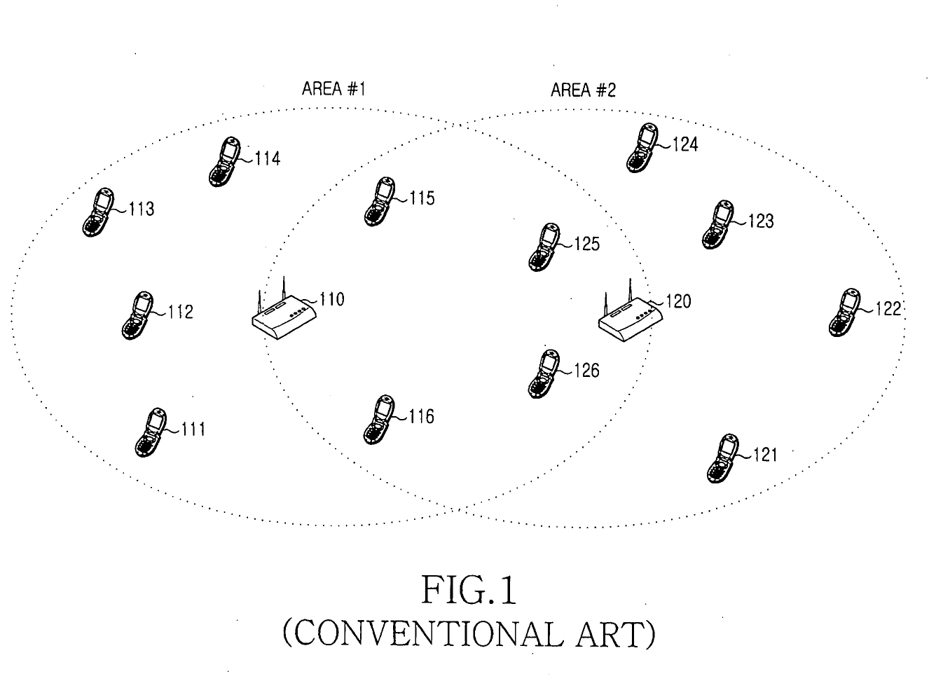

Throughout the drawings, the same drawing reference numerals will be understood to refer to the same elements, features, and structures

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness

Exemplary embodiments of the present invention are intended to enable a receiving mesh node to consider a transmitting mesh node a legacy STA in a mesh network. To serve this purpose, the exemplary transmitting mesh node and receiving mesh node each recognize the other party by channel scanning, before data transmission starts. A data transmission procedure between a mesh node and a legacy STA also applies for data transmission between mesh nodes. In addition, an exemplary technique for the transmitting mesh mode to transition a legacy terminal vulnerable to the effect of a signal sent from the transmitting mesh node to a wait state is provided.

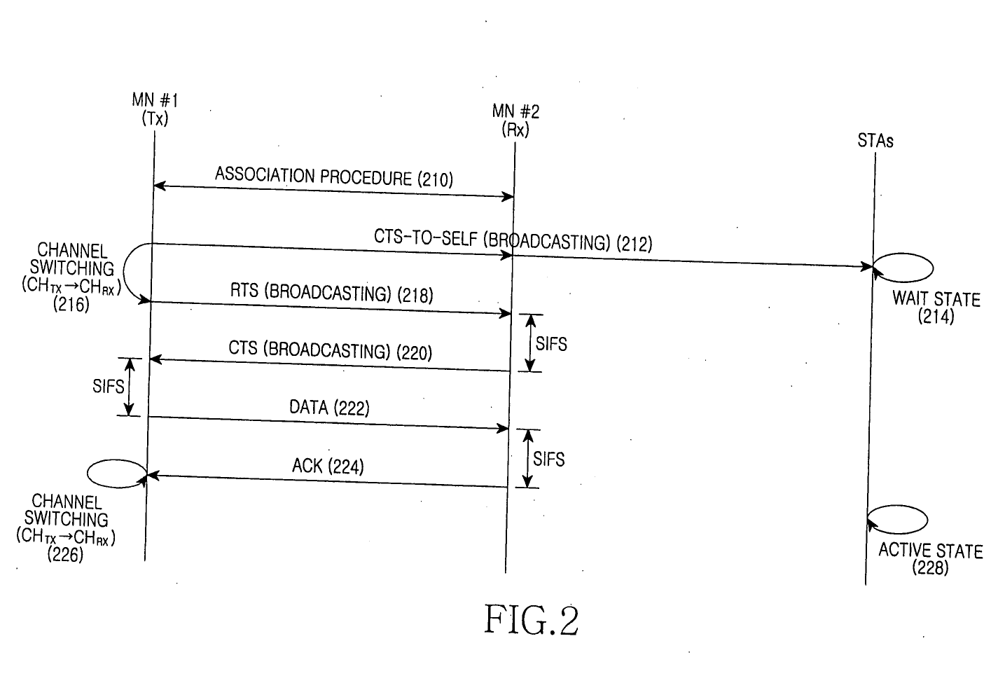

FIG. 2 is a diagram illustrating a signal flow for data transmission between mesh nodes in a mesh network according to an exemplary embodiment of the present invention. In FIG. 2, a first mesh node MN #1 and a second mesh node MN #2 are assumed to be transmitting and receiving mesh nodes, respectively. MN #1 has one or more neighbor mesh nodes and MN #2 is one of them.

Referring to FIG. 2, MN #1 performs an association procedure with MN #2 in step 210. The association procedure can be a typical one used in a mobile access network. By the association, MN #1 recognizes that MN #2 is a neighbor mesh node.

Upon generation of data to be transmitted to MN #2, MN #1 broadcasts a state transition control message with MN #1 set as a destination in step 212. The state transition control message is not destined for a specific mesh node or legacy STA. For example, it can be a Clear to Send (CTS) message defined in the mobile access network. As stated above, the destination of the CTS message is written as MN #1. MN#1 uses a pre-allocated transmission channel CHTX in broadcasting the state transition control message.

Upon receipt of the state transition control message, legacy STAs finds out that MN #1 will initiate data transmission to MN #2. Hence, the legacy STAs transition to a wait state in step 214. Preferably, the state transition control message indicates a wait state duration. The wait state duration is used as information by which the legacy STAs wake up to an active state. That is, the legacy STAs are kept in the wait state until the wait state duration expires. The wait state duration can be determined, taking into account the amount of the transmission data and an average time to start data transmission and is set as a Network Allocation Vector (NAV) in the state transition control message.

In step 216, MN #1 switches from CHTX to a pre-allocated reception channel CH_{RX}. With the channel switching, MN #1 now acts as a legacy STA for MN #2.

In step 218, MN #1 sends a data transmission request control message on the transmission channel CH_{RX}. For example, the data transmission request control message can be a Request to Send (RTS) message defined in the mobile access network. As stated before, MN #1 operates as a legacy STA for MN #2. Therefore, MN #1 competes with legacy STAs associated with MN #2 in order to send the data transmission request control message. Since MN #1 attempts to send data to the network of MN#2, it sets a corresponding address with the aid of a Medium Access Control (MAC)-level or higher-level protocol. For instance, MN #2 is considered a gateway for MN #1.

Neighbor mesh nodes of MN #1 receive the data transmission request control message. MN #2, which has received the data transmission request control message, broadcasts a data transmission response control message when a predetermined delay called Short Inter-Frame Space (SIFS) elapses, in step 220. A CTS message defined in the mobile access network can be used as the data transmission response control message.

Upon receipt of the data transmission response control message, MN #1 sends data when the SIFS elapses in step 222. An SIFS later, MN #2 sends a response message in step 224. If MN #2 has received the data successfully, it sends an ACKnowledgement (ACK) signal. If the data reception is failed, MN #2 does not send the ACK signal.

When MN#1 does not receive the ACK signal from MN #2, it retransmits the data in the procedure illustrated in FIG. 2. On the contrary, upon receipt of the ACK signal from MN #2, MN #1 changes the channel, that is, switches from CH_{R}X to CH_{TX} in step 226.

Meanwhile, the legacy STAs transition from a wait state to an active state, when the wait state duration set in the state transition control message elapses, in step 228. Thus, the legacy STAs are now able to communicate with MN #1. The state of the legacy STAs is determined by an NAV. Since the NAV decreases with time, the legacy STAs transition to the active state when the NAV is 0.

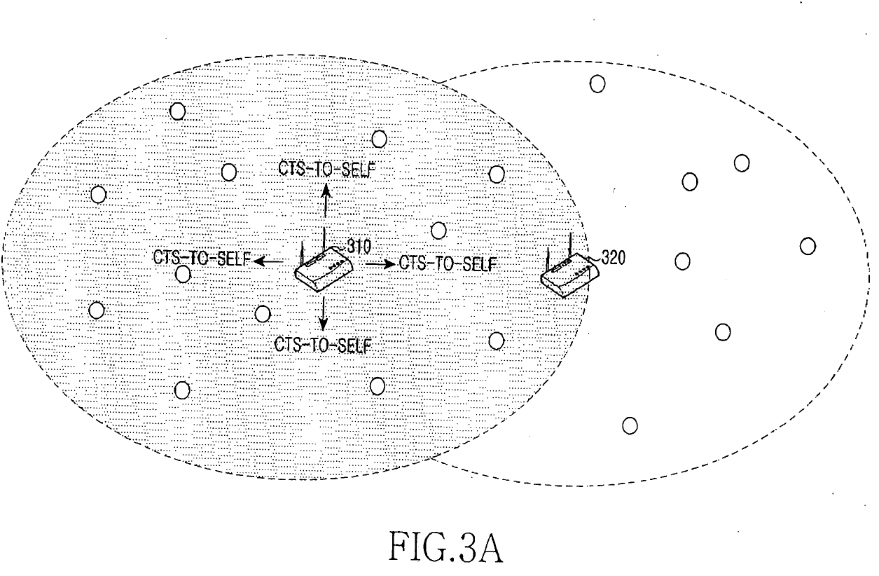

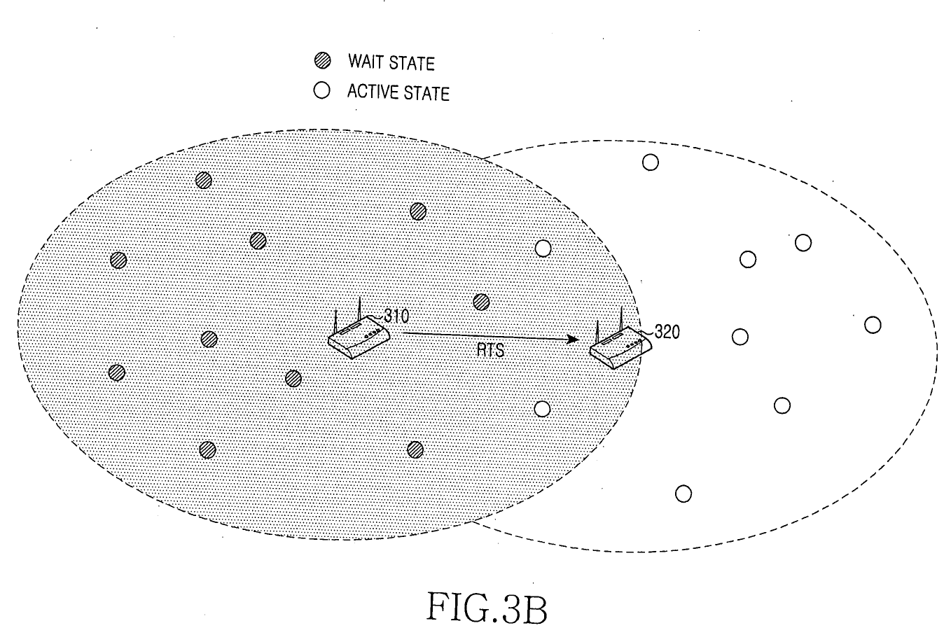

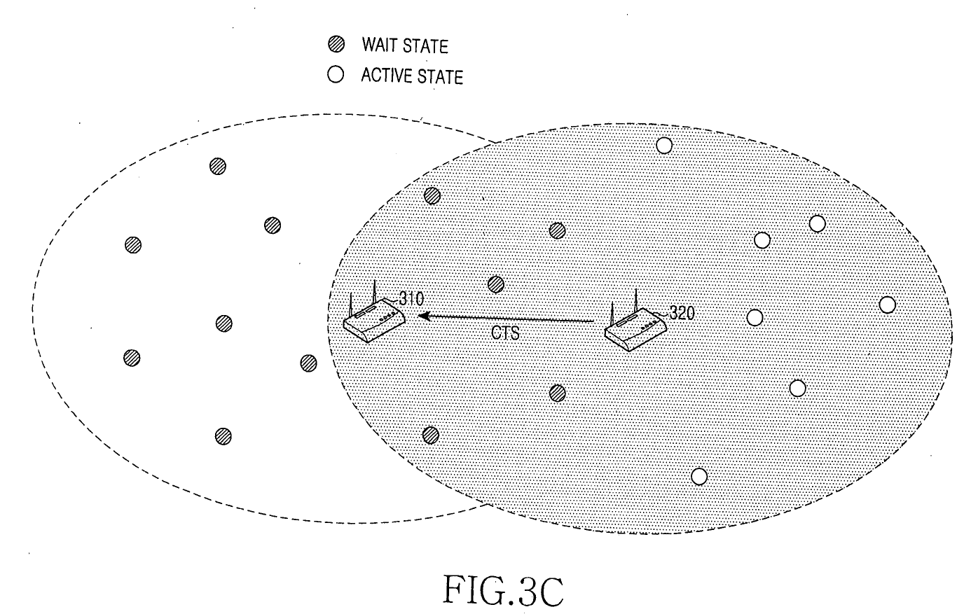

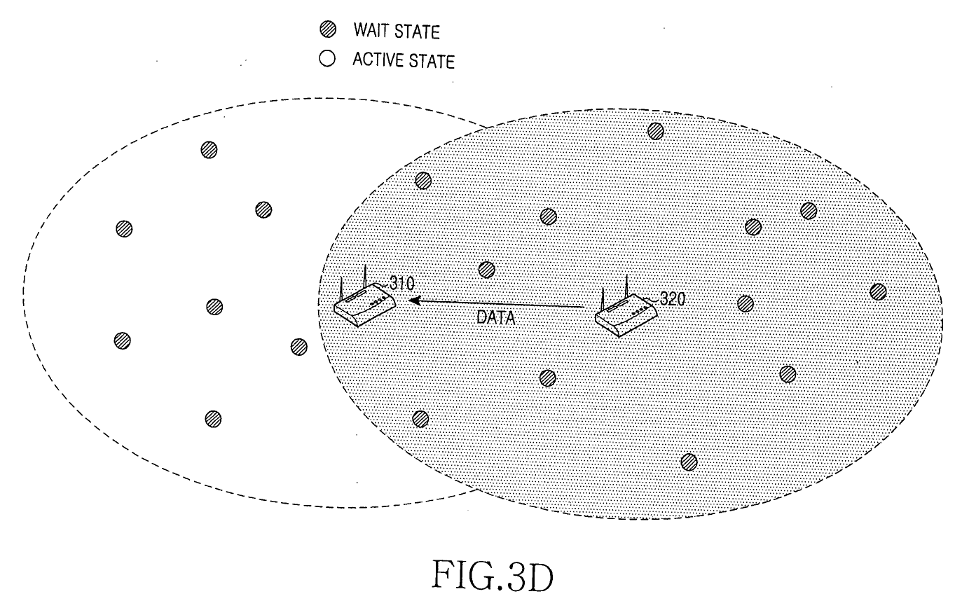

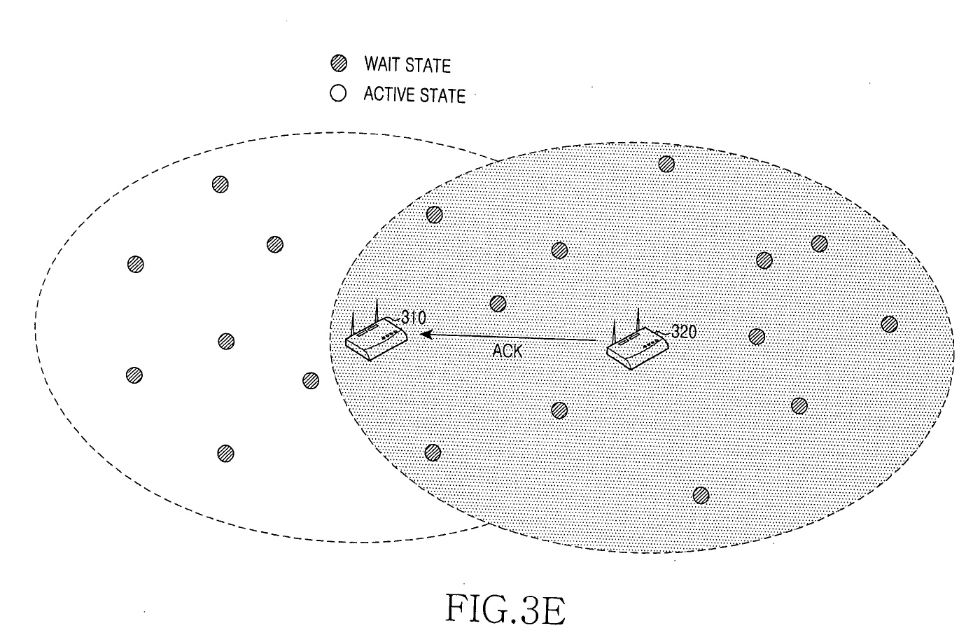

FIGS. 3A to 3E illustrate a mesh network state in each step of the data transmission procedure between mesh nodes according to an exemplary embodiment of the present invention.

FIG. 3A illustrates a mesh network state in the step of broadcasting a CTS to SELF message by a transmitting mesh node 310. In this step, all legacy STAs are in the active state.

FIG. 3B illustrates a mesh network state in the step of sending an RTS message from the transmitting mesh node 310 to a receiving mesh node 320. In this step, all legacy STAs associated with the transmitting mesh node 310 are transitioned to the wait state. Hence, every legacy STA associated with the transmitting mesh node 310 is not affected by the RTS message. Meanwhile, legacy STAs associated with the receiving mesh node 320 are kept in the active state.

FIG. 3C illustrates a mesh network state in the step of sending a CTS message from the receiving mesh node 320 to the transmitting mesh node 310. In this step, part of the legacy STAs associated with the receiving mesh node 320 as well as all legacy STAs associated with the transmitting mesh node 310 are transitioned from the active state to the wait state, so that they are not affected by the CTS message. The other legacy STAs associated with the receiving mesh node 320 are kept in the active state.

FIG. 3D illustrates a mesh network state in the step of sending data from the transmitting mesh node 310 to the receiving mesh node 320. In this step, all legacy STAs associated with the transmitting and receiving mesh nodes 310 and 320 are transitioned from the active state to the wait state, so as not to be affected by the data transmitted from the transmitting mesh node 310.

FIG. 3E illustrates a mesh network state in the step of sending a response signal from the receiving mesh node 320 to the transmitting mesh node 310. In this step, all legacy STAs associated with the transmitting and receiving mesh nodes 310 and 320 are transitioned from the active state to the wait state, so as not to be affected by the response signal transmitted from the receiving mesh node 320.

Thereafter, all legacy STAs associated with the transmitting and receiving mesh nodes 310 and 320 will be transitioned from the wait state to the active state.

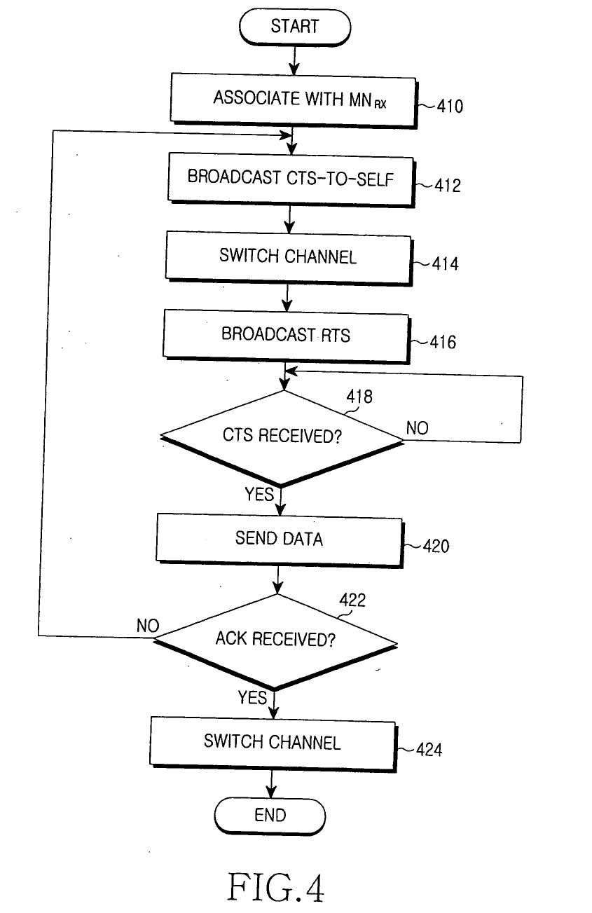

FIG. 4 is a flowchart illustrating a control operation for data transmission between mesh nodes in the transmitting mesh node according to an exemplary embodiment of the present invention.

Referring to FIG. 4, the transmitting mesh node associates with the receiving mesh node, MN_{RX} by detecting MN_{RX} in step 410. Then the transmitting mesh node determines whether there are data to be transmitted to MN_{RX}. This step is not shown in FIG. 4.

In the presence of transmission data, the transmitting mesh node broadcasts a CTS to SELF message in step 412 and switches a current channel to a channel by which to communicate with MNRX in step 414.

In step 416, the transmitting mesh node broadcasts an RTS message on the switched channel, indicating that data will be sent to MN_{RX}. The transmitting mesh node monitors reception of a CTS message permitting the data transmission on the switched channel in step 418.

Upon receipt of the CTS message, the transmitting mesh node sends the data on the switched channel in step 420 and monitors reception of an ACK signal for the transmitted data in step 422. If it fails to receive the ACK signal from MN_{RX}, the transmitting mesh node repeats steps 412 to 420. On the contrary, upon receipt of the ACK signal from MN_{RX}, the transmitting mesh node transitions to a channel by which it can communicate with a legacy STA in step 424.

Since exemplary embodiments of the present invention bring about no change in the operation of the receiving mesh node, that is, the receiving mesh node can receive data from the transmitting mesh node in the same procedure as used for receiving data from the legacy STA, a detailed description of the operation of the receiving mesh node is not provided herein.

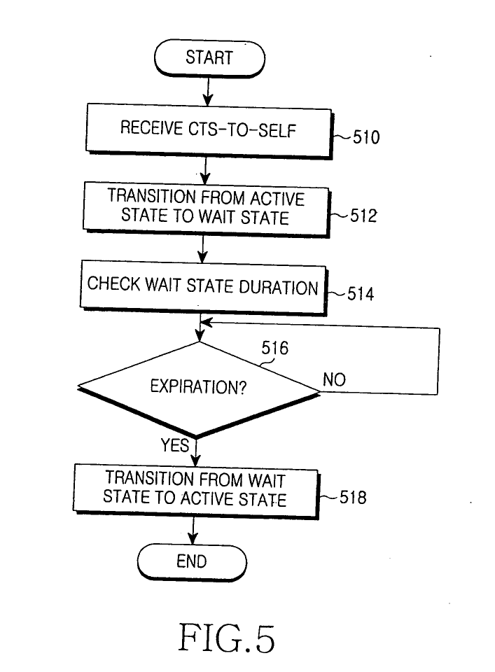

FIG. 5 is a flowchart illustrating a control operation for data transmission between mesh nodes in the legacy STA according to an exemplary embodiment of the present invention.

Referring to FIG. 5, the legacy STA receives a CTS message destined for the transmitting mesh node in step 510 and changes the current operation state, in other words traditions to the wait state in step 512. In step 514, the legacy STA checks information about a wait state duration from the CTS message.

In step 516, the legacy STA monitors expiration of the wait state duration. Upon expiration of the wait state duration, the legacy STA transitions from the wait state to the active state in step 518.

In accordance with exemplary embodiments of the present invention as described above, a distribution adjusting scheme is still used without applying a power saving mode or separating a transmission period, thereby causing no transmission delay. Furthermore, the absence of an unnecessary transmission period prevents a resource waste.

While the invention has been shown and described with reference to certain exemplary embodiments thereof, it will be understood by those skilled in the art that various changes in form and details may be made therein without departing from the spirit and scope of the invention as defined by the appended claims and the full scope of equivalents thereof.

What is claimed is:

1. A data transmission method in a mesh node having a single radio interface in a mesh network supporting multiple channels, the method comprising:
establishing a connection with at least one neighbor mesh node;
broadcasting a control message upon generation of data to be transmitted to the neighbor mesh node;
reserving data transmission to the neighbor mesh node by competing with at least one legacy station (STA) connected to the neighbor mesh node; and
transmitting the data to the neighbor mesh node.

2. The data transmission method of claim 1, wherein a legacy STA which has received the control message transitions to a wait state.

3. The data transmission method of claim 2, wherein the control message comprises information about a wait state duration.

4. The data transmission method of claim 3, wherein the wait state duration is determined based on an amount of the data and an average time to an actual data transmission.

5. The data transmission method of claim 4, wherein the at least one legacy STA connected to the neighbor mesh node transitions to the wait state when the mesh node reserves the data transmission or the neighbor mesh node permits the data transmission.

6. The data transmission method of claim 1, further comprising switching to a channel by which to communicate with the neighbor mesh node, after transmitting the control message destined for the mesh node.

7. The data transmission method of claim 6, further comprising:
receiving a response signal for the transmitted data from the neighbor mesh node;
determining from the response signal whether the neighbor mesh node has received the data successfully; and
switching to a channel by which to communicate with a legacy STA, if the neighbor mesh node has received the data successfully.

8. A data transmission system in a mesh network supporting multiple channels, the system comprising:
a receiving mesh node for permitting data transmission by a transmitting mesh node which has competed with at least one legacy station (STA) connected to the receiving mesh node;
the transmitting mesh node for establishing a connection with the receiving mesh node and transmitting data to the receiving mesh node; and
at least one legacy STA connected to the transmitting mesh node,
wherein the transmitting mesh node has a single radio interface and is adapted to broadcast a control message, upon generation of data to be transmitted to the receiving mesh node, reserving the data transmission to the neighbor mesh node by competing with the at least one legacy STA connected to the receiving mesh node, and transmitting the data to the receiving mesh node.

9. The data transmission system of claim 8, wherein the at least one legacy STA connected to the transmitting mesh node transitions to a wait state, upon receiving the control message.

10. The data transmission system of claim 9, wherein the at least one legacy STA connected to the transmitting mesh node is kept in the wait state according to information about a wait state duration included in the control message.

11. The data transmission system of claim 10, wherein the transmitting mesh node determines the wait state duration based on an amount of the data and an average time to an actual data transmission.

12. The data transmission system of claim 11, wherein the at least one legacy STA connected to the receiving mesh node transitions to the wait state when the transmitting mesh node reserves the data transmission reservation or the receiving mesh node permits the data transmission.

13. The data transmission system of claim 8, wherein the transmitting mesh node switches to a channel by which to communicate with the neighbor mesh node, after transmitting the control message.

14. The data transmission system of claim 13, wherein the transmitting mesh node receives a response signal for the transmitted data from the receiving mesh node, determines from the response signal whether the receiving mesh node has received the data successfully, and switches to a channel by which to communicate with the legacy STA connected to the transmitting mesh node, if the receiving mesh node has received the data successfully.

15. The data transmission method of claim 1, wherein broadcasting a control message comprises broadcasting a control message destined for the mesh node.

16. The data transmission method of claim 1, wherein transmitting the data to the neighbor mesh node comprises transmitting the data when the neighbor mesh node permits the data transmission.

17. The data transmission system of claim 8, wherein the broadcast control message is destined for the transmitting mesh node.

18. The data transmission system of claim 8, wherein the data is transmitted to the receiving mesh node when the neighbor mesh node permits the data transmission.
